(19) United States
(12) Patent Application Publication
(10) Pub. No.: US 2011/0021305 A1
(43) Pub. Date: Jan. 27, 2011

(54) DIFFERENTIAL HAVING SELF-ADJUSTING GEARING

(76) Inventor: Stephen P. Radzevich, Sterling Heights, MI (US)

Correspondence Address: Bliss McGlynn, P.C., Suite 600, 2075 West Big Beaver Road, Troy, MI, 48084, US

(21) Appl. No.: 12/509,637

(22) Filed: Jul. 27, 2009

(51) Int. Cl. F16H 48/08

(52) U.S. Cl. 475/230

(57) ABSTRACT

A differential for use in a vehicle drive train including a gear case that is operatively supported in driven relationship with respect to the drive train and a spider mounted for rotation with the gear case. The spider includes at least one pair of cross pins. Each cross pin defines a longitudinal axis and an outer surface that is convex about an axis extending perpendicular to the longitudinal axis of the cross pin. Pinion gears include a central bore where the cross pins are received in the central bore of the pinion gears such that the gears are mounted for rotation with the spider and in meshing relationship with side gears with an increased degree of rotational freedom of the pinion gears about the convex surface of the cross pin. Alternatively, the central bore of the cross pin may have an inner surface that is convex along the axis of the central bore.

### BACKGROUND OF THE INVENTION

1. Field of the Invention

The present invention relates, generally, to differentials, and more specifically to a differential having self-adjusting gearing.

2. Description of the Related Art

Differentials are well known devices used in vehicle drive trains. These devices operate to couple a pair of rotating members, such as drive shafts or axle half shafts about a rotational axis. Thus, differentials have been employed as a part of transfer cases that operatively couple the front and rear axles of a vehicle, in open differentials as well as limited slip and locking differentials used to couple axle half shafts, and other applications commonly known in the art.

Differentials of the type known in the related art may include a housing and a gear case that is operatively supported by the housing for rotation by a vehicle drive train. The differential typically includes at least a pair of side gears. The side gears are splined for rotation with a pair of rotating members, such as axle half shafts. A spider having cross pins is operatively mounted for rotation with the gear case. Pinion gears are mounted for rotation with the cross pins and in meshing relationship with the side gears. The pinion gears typically include central bores that define cylindrical surfaces designed to mate with the outer cylindrical surface of the cross pin. Differential rotation of the side gears and thus the axle half shafts may be obtained through rotation of the pinions relative to the cross pins as is commonly known in the art.

While differentials ofthe type generally known in the art and as described above have worked for their intended purposes, certain disadvantages remain. More specifically, there remains ongoing and continuous efforts to improve the operation of such differentials. One problem associated with such differentials is the need for the mating surfaces between the pinion gears and the cross pins as well as between the pinion gears and the side gears to smoothly and efficiently interact. One way to achieve this result includes increasing the precision in the manufacturing process used to manufacture the cross pin, pinion gears, and side gears. Unfortunately, increased precision also results in increased cost to manufacture these devices. Ultimately, however, there is a limitation on the level of precision that may be achieved in any manufacturing process. Manufacturing deviations are ultimately unavoidable.

Thus, there remains a need in the art for a differential that allows for the smooth meshing interaction between the pinion gears and its associated cross pin and side gears without increasing the cost of manufacture.

### SUMMARY OF THE INVENTION

The present invention overcomes the disadvantages in the related art in a differential for use in a vehicle drive train including a pair of rotary members. The differential includes a gear case operatively supported in driven relationship with respect to the vehicle drive train. A pair of side gears is mounted for rotation with a respective one of the rotary members in the gear case. A spider is mounted for rotation with the gear case. The spider includes at least one pair of cross pins. Each cross pin defines a longitudinal axis and an outer surface that is convex about an axis extending perpendicular to the longitudinal axis of the cross pin. The differential also includes at least one pair of pinion gears. Each of the pinion gears includes a central bore. Each of the cross pins is received in a central bore of a corresponding one of the pinion gears such that the pinion gears are mounted for rotation with the spider and in meshing relationship with the side gears with an increased degree of rotational freedom of the pinion gears about the convex surface of the cross pins.

Alternatively, the present invention is also directed toward a differential wherein each ofthe central bores ofthe pinion gears define an inner surface that is convex about an axis extending perpendicular to the axis of the central bore. The cross pins are received in the central bore of a corresponding one of the pinion gears such that the pinion gears are mounted for rotation with the spider and in meshing relationship with the side gears with an increased degree of rotational freedom of the pinion gears about the cross pins.

When the shape of the cross pin along its axis or the central bore of the pinion gear are modified in this way, they allow the pinion gear and side gear to self-adjust relative to one another through very small angles, but which results in a greater degree of freedom relative to one another. This increased degree of freedom and self-adjustment capability also compensate for the unavoidable deviations in precision that result in any manufacturing process. Moreover, this self-adjusting feature is not detrimental to the operation of the differential because ofthe low revolutions per minute of most differential movements in automotive applications. Accordingly, the present invention results in a differential that facilitates smooth operation of the meshing gears, but which may be manufactured at a relatively low cost.

### BRIEF DESCRIPTION OF THE DRAWINGS

Other objects, features and advantages of the present invention will be readily appreciated, as the same becomes better understood after reading the subsequent description taken in connection with the accompanying drawings wherein:

FIG. 1 is a cross-sectional side view of a representative example of a differential of the type that may employ the present invention;

FIG. 2 is a partial cross-sectional side view of a spider having cross pins and pinions of the type known in the related art;

FIG. 2A is an enlarged partial cross-sectional side view illustrating the mating surfaces between the cross pin and the central bore of a pinion gear of the type known in the related art;

FIG. 3 is a partial cross-sectional side view of a spider having a cross pin with a convex outer surface of the present invention;

FIG. 3A is an enlarged partial cross-sectional side view illustrating the interaction between a cross pin having a convex outer surface and the central bore ofthe pinion gear ofthe type employed in the present invention;

FIG. 4 is a partial cross-sectional side view of a spider having pinion gears with a central bore having an inner surface that is convex of the type employed in the present invention; and

FIG. 4A is an enlarged partial cross-sectional side view illustrating the interaction of the convex central bore of the pinion gear relative to the cross pin of the type employed in the present invention.

### DETAILED DESCRIPTION

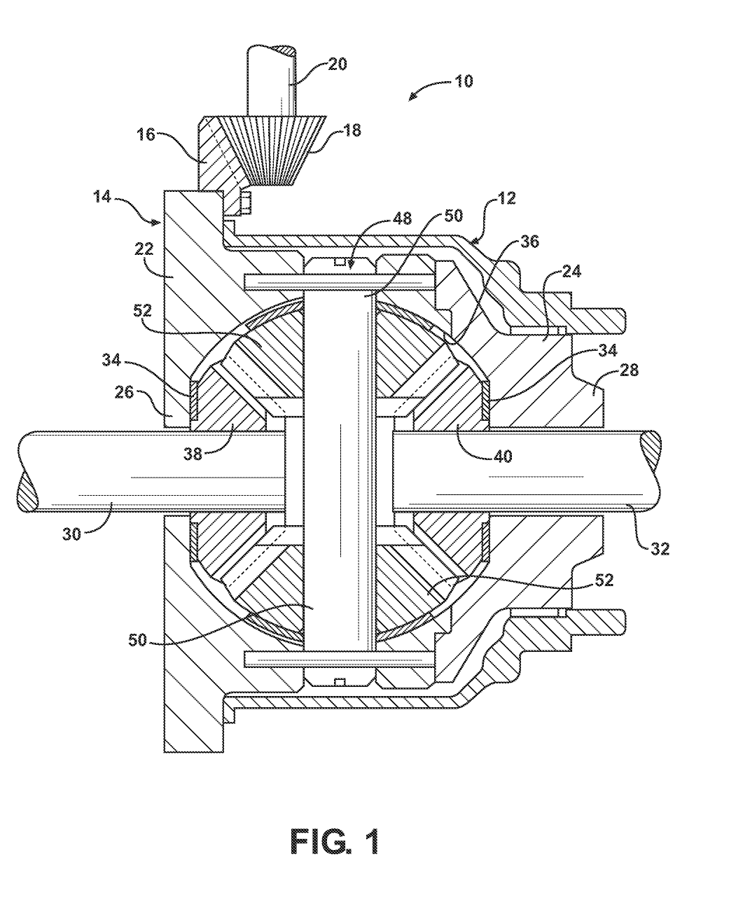

One representative embodiment of a differential of the type that may employ a spider having a cross pin or pinion gear of the type contemplated by the present invention is generally indicated at 10 in FIG. 1, where like numerals are used to designate like structure throughout the drawings. The differential 10 is designed to be employed as a part of a drive train for any number of vehicles having a power plant that is used to provide motive force to the vehicle. Thus, those having ordinary skill in the art will appreciate that the differential 10 may be employed as a part of a transfer case that operatively couples the front and rear axis of a vehicle, in an open differential, a limited slip differential or locking differential used to couple axle half shafts, as well as other applications commonly known in the art. The limited slip or locking differentials may be hydraulically actuated or electronically actuated and therefore include coupling mechanisms, such as friction clutches employed to operatively couple the axle half shafts together under certain operating conditions. Those having ordinary skill in the art will appreciate from the description that follows that the purpose of the differential 10 illustrated in FIG. 1 is merely to provide one basic representative example of a device that may employ the features ofthe present invention, and is not meant to limit the application of the present invention to the type of differential represented therein.

With this in mind, in its most elementary configuration, the differential 10 may include a housing, generally indicated at 12. A gear case, generally indicated at 14, may be operatively supported in the housing 12 for rotation in driven relationship by the drive train, as is commonly known in the art. To this end, a ring gear 16 may be operatively mounted to the gear case 14. The ring gear 16 is typically designed to be driven in meshing relationship with a pinion gear 18 fixed to a drive shaft 20 or some other driven mechanism. The gear case 14 may be defined by two end portions 22, 24 that are operatively fixed together in any conventional manner known in the related art. Those having ordinary skill in the art will appreciate from the description that follows that the gear case 14 and housing 12 may be defined by any conventional structure known in the related art and that the present invention is not limited to the particular housing 12 illustrated here nor a gear case 14 defined by two end portions 22, 24. Similarly, the gear case 14 may be driven by any conventional drive mechanism known in the related art and that the invention is not limited to a gear case 14 that is driven via a ring gear, pinion, and drive shaft.

Each end portion 22, 24 of the gear case 14 may include a hub 26, 28 that supports one of a pair of rotary members, such as axle half shafts 30, 32 with the aid of bearings 34 or the like. The gear case 14 defines a cavity 36. A pair of side gears 38, 40 are mounted for rotation with a respective one of a pair of rotary members 42, 44 in the cavity 36 defined by the gear case 14. Typically, the side gears 38, 40 are each splined to a corresponding one of the rotary members 30, 32. A spider, generally indicated at 48, is mounted for rotation with the gear case 14. The spider 48 includes at least one pair of cross pins 50. In addition, the differential 10 also includes at least one pair of pinion gears 52. In the embodiment illustrated in these figures, the spider 48 includes two pair of cross pins 50 and two pair of pinion gears 52. Each of the pinion gears 52 is mounted for rotation on a corresponding cross pins 50 and in meshing relationship with a corresponding one of the pair of side gears 38, 40.

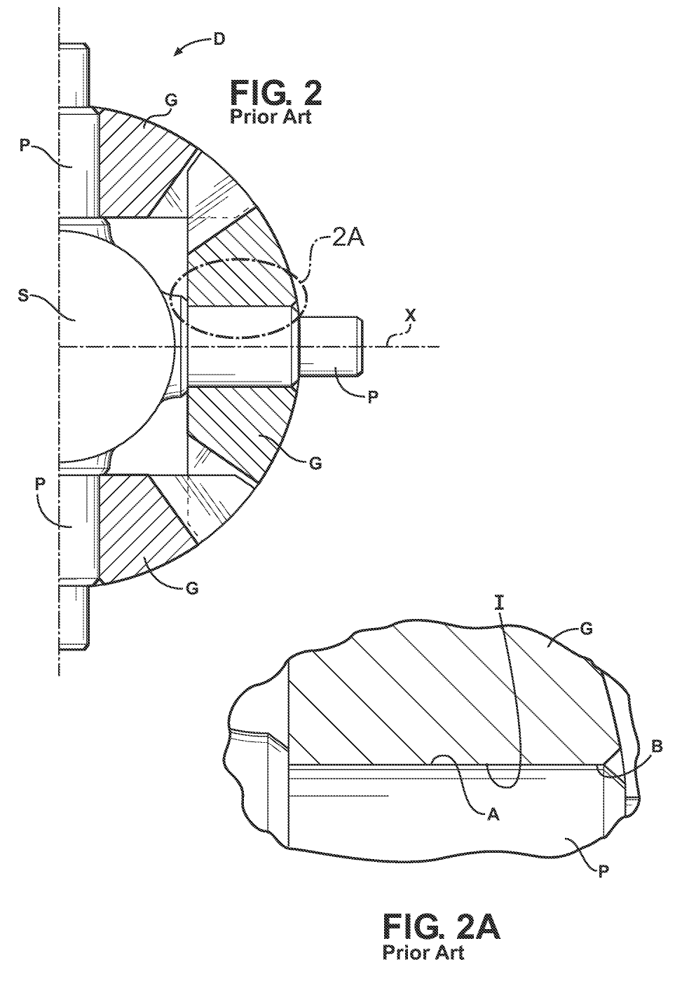

With this background in mind, attention is now directed to FIGS. 2 and 2A wherein a half portion of a differential D that employs a spider S having four cross pins P (with three illustrated in these figures) and four pinion gears G of the type generally known in the related art is illustrated. As best shown in FIG. 2A, the cross pin P defines a basic annular surface A that extends about the axis X of each pin P. The pinion gear G defines a central bore B with an inner surface I that compliments the surface A of the cross pin P and defines an annular surface in mating relationship with the cross pin along its axis. Thus, the pinion gears are journaled for rotation about cross pin and adapted for meshing relationship with the side gear. It is important that the pinion gear and side gears mesh smoothly with as little energy loss to friction as possible. In the related art, this objective is achieved by increasing the precision of the mating surfaces between the cross pin and the pinion gear. In addition, the manufacture of these components may also include extensive heat treat and polishing to achieve this result. Unfortunately, the efforts to achieve this level of precision and reduce friction or other losses increase the cost of manufacturing the differential of the type known in the related art. Moreover, no matter how much effort is expended to increase the precision of the interacting surfaces, the manufacturing processes are never perfect. Thus, deviations from optimal designs will always be found. These deviations result in increased friction and energy losses through the differential.

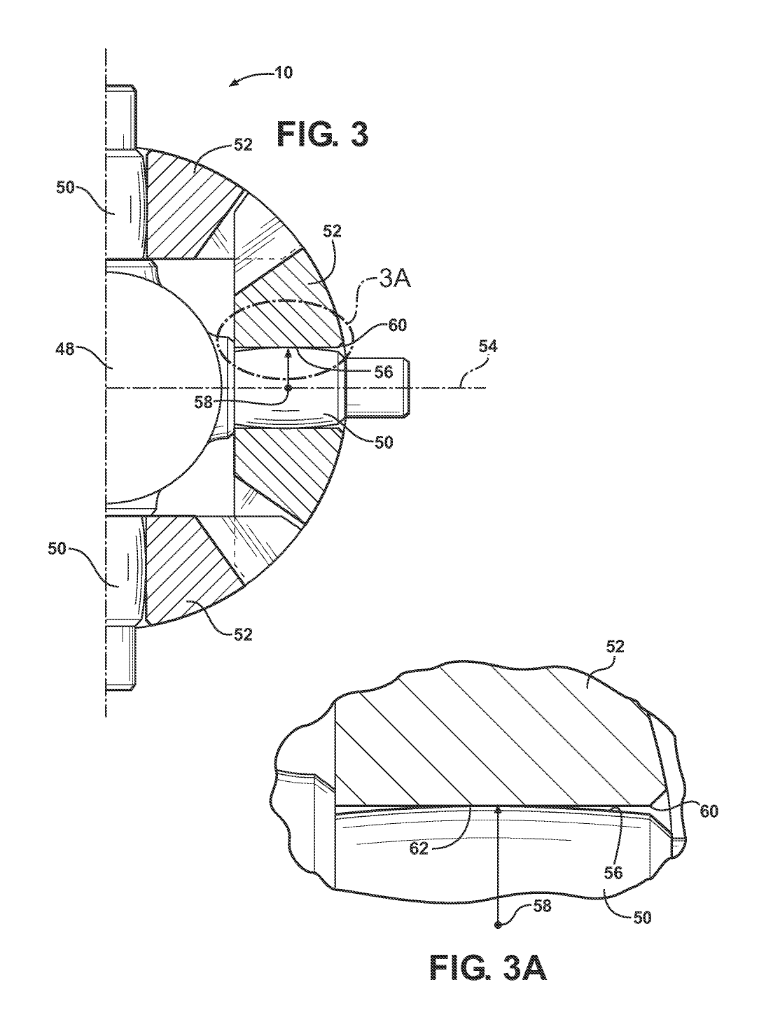

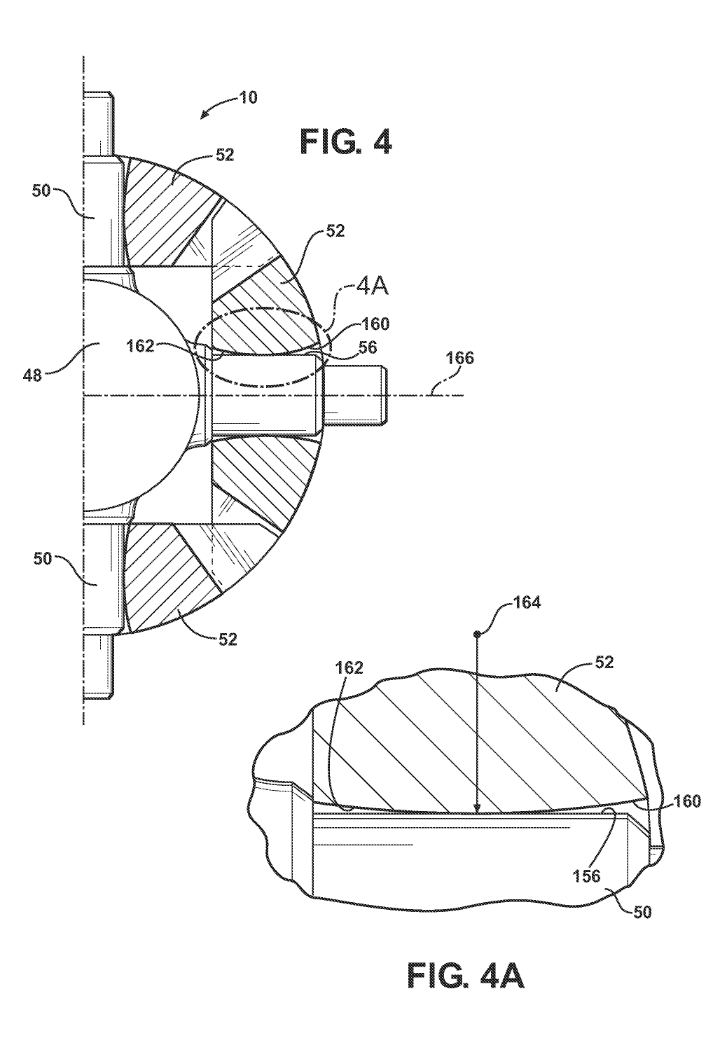

The present invention overcomes these deficiencies in the related art in a differential 10 that employs a particular configuration of the cross pin 50 of the spider 48 and the pinion gears 52 that are illustrated in FIGS. 3-3A and 4-4A. More specifically, and referring to FIGS. 3 and 3A, each cross pin 50 of the present invention defines a longitudinal axis 54 and an outer surface 56 that is convex about an axis, representatively designated at 58, extending perpendicular to the longitudinal axis 54 of the cross pin 50. As illustrated in FIGS. 3-3A and from the reader's viewpoint, the axis 58 extending into the page. Each of the pinion gears 52 includes a central bore 60. In one embodiment, the inner surface 62 of the central bore is annular about the axis of the bore. Each of the cross pins 50 is received in the central bore 60 of a corresponding one of the pinion gears such that the pinion gears 52 are mounted for rotation with the spider 48 and in meshing relationship with the side gears 38, 40 with an increased degree of rotational freedom of the pinion gears 52 about the convex surface 56 of the cross pins 50. More specifically, the convexity of the cross pin 50 facilitates the adjustability of the pinion gear 52 relative to the cross pin 50 and therefore facilitates smooth meshing relationship between the pinion gear 52 and the side gear 38, 40 while allowing for adjustability of the pinion gear 52 relative to the cross pin 50. All these features are facilitated by the convexity of the outer surface 56 of the cross pin 50. Thus, those having ordinary skill in the art will appreciate that the convexity of the surface 56 may define an arc that forms a part of a theoretical circle. Alternatively, the arc may form the part of a theoretical ellipse. On the other hand, the arc may form a part of a theoretical curve that does not define either a circle or an ellipse. Those having ordinary skill in the art will appreciate that the convexity ofthe cross pin 50 has been exaggerated for illustrative purposes in FIGS. 3 and 3A.

Another embodiment of the differential of the present invention is illustrated in FIGS. 4 and 4A, where like numerals are used to designate like structure and where some of these numerals are increased by 100 with respect to the embodiment illustrated in FIGS. 3 and 3A. In the embodiment illustrated in FIGS. 4 and 4A, the convex surface 162 is formed in the central bore 160 of the pinion gear 52. The outer surface 156 of the cross pin 50 is annular. The central bores 160 define an inner surface 162 that is convex about an axis 164 extending spaced from but perpendicular to the axis 166 of the central bore 160 of the pinion gears 52. As illustrated in FIG. 4A and from the reader's viewpoint, the axis 164 extends into the page. The cross pins 50 are received in the central bore 160 of a corresponding one of the pinion gears 52 such that the pinion gears 52 are mounted for rotation with the spider 48 and in meshing relationship with the side gears 38, 40 with an increased degree of rotational freedom of the pinion gears 52 about the cross pin 50. In this regard, the embodiment illustrated in FIGS. 4 and 4A enjoys all of the features and benefits of the embodiment illustrated in FIGS. 3 and 3A. Moreover, and as noted with respect to the embodiment illustrated in FIGS. 3 and 3A, the convex inner surface 162 ofthe central bore 160 may define an arc that forms a part of a theoretical circle. Alternatively, the convex inner surface 162 of the central bore 160 may define an arc that forms a part of a theoretical ellipse. On the other hand, the convex inner surface 162 of the central bore 160 may define an arc that does not form a part of a theoretical circle or ellipse, but rather forms a part of a theoretical curve. Those having ordinary skill in the art will appreciate that the convexity of the inner surface 162 of the bore 60 has been exaggerated for illustrative purposes in FIGS. 4 and 4A.

When the surface 56 of the cross pin 50 along its axis or the central bore 160 of the pinion gear 52 are modified in this way, they allow the pinion gear 52 and side gears 38, 40 to self-adjust relative to one another through very small angles, but which results in a greater degree of freedom relative to one another. This increased degree of freedom and self-adjustment capability also compensate for the unavoidable deviations in precision that result in any manufacturing process. Moreover, this self-adjusting feature is not detrimental to the operation of the differential because of the low revolutions per minute of most differential movements in automotive applications. Accordingly, the present invention results in a differential that facilitates smooth operation of the meshing gears, but which may be manufactured at a relatively low cost.

The invention has been described in great detail in the foregoing specification, and it is believed that various alterations and modifications of the invention will become apparent to those having ordinary skill in the art from a reading and understanding of the specification. It is intended that all such alterations and modifications are included in the invention, insofar as they come within the scope of the appended claims.

I claim:

1. A differential for use in a vehicle drive train including a pair of rotary members, said differential comprising:
a gear case operatively supported in driven relationship with respect to the vehicle drive train, a pair of side gears mounted for rotation with a respective one of the rotary members in said gear case, a spider mounted for rotation with said gear case, said spider including at least one pair of cross pins, each cross pin defining a longitudinal axis and an outer surface that is convex about an axis extending perpendicular to said longitudinal axis of said cross pin;
at least one pair of pinion gears, each of said pinion gears including a central bore, each of said cross pins received in a central bore of a corresponding one of said pinion gears such that said pinion gears are mounted for rotation with said spider and in meshing relationship with said side gears with an increased degree of rotational freedom of said pinion gears about said convex surface of said cross pins.

2. A differential as set forth in claim 1 wherein the convex outer surface of said cross pins define an arc that forms a part of a theoretical circle.

3. A differential as set forth in claim 1 wherein the convex outer surface of said cross pins define an arc that forms a part of a theoretical ellipse.

4. A differential as set forth in claim 1 wherein the convex outer surface of said cross pins define an arc that forms a part of a theoretical curve.

5. A differential as set forth in claim 1 wherein said differential further includes a housing with said gear case supported for rotation in said housing.

6. A differential as set forth in claim 1 wherein said spider includes two pair of cross pins and two pair of pinion gears, each pair of pinion gears mounted for rotation on a corresponding pair of cross pins and in meshing relationship with a corresponding one of said pair of side gears.

7. A differential for use in a vehicle drive train including a pair of rotary members, said differential comprising:
a gear case operatively supported in drive relationship with respect to the vehicle drive train, a pair of side gears mounted for rotation with a respective one of the rotary members in said gear case, a spider mounted for rotation with said gear case, said spider including at least one pair of cross pins;
at least one pair of pinion gears, each of said pinion gears including a central bore defined about an axis, each of said central bores defining an inner surface that is convex about an axis extending perpendicular to said axis of said central bore, said cross pins being received in said central bore of a corresponding one of said pinion gears such that said pinion gears are mounted for rotation with said spider and in meshing relationship with said side gears with an increased degree of rotational freedom of said pinion gears about said cross pins.

8 . A differential as set forth in claim 7 wherein said convex inner surface of said central bore defines an arc that forms a part of a theoretical circle.

9. A differential as set forth in claim 7 wherein said convex inner surface of said central bore defines an arc that forms a part of a theoretical ellipse.

10. A differential as set forth in claim 7 wherein said convex inner surface of said central bore defines an arc that forms a part of a theoretical curve.

11. A differential as set forth in claim 7 wherein said differential further includes a housing with said gear case supported for rotation in said housing.

12. A differential as set forth in claim 7 wherein said spider includes two pair of cross pins and two pair of pinion gears, each pair of pinion gears mounted for rotation on a corresponding pair of cross pins and in meshing relationship with a corresponding one of said pair of side gears.

13. A differential for use in a vehicle drive train including a pair of rotary members, said differential comprising:
a housing and a gear case supported in said housing in driven relationship with respect to the vehicle drive train, a pair of side gears mounted for rotation with a respective one of the rotary members in said gear case, a spider mounted for rotation with said gear case, said spider including two pairs of cross pins, each cross pin defining a longitudinal axis and an outer surface that is convex about an axis extending perpendicular to said longitudinal axis of said cross pin;
two pair of pinion gears, each of said pinion gears including a central bore, each of said cross pins received in a central bore of a corresponding one of said pinion gears such that said pinion gears are mounted for rotation about said spider and in meshing relationship with said side gears with an increased degree of rotational freedom of said pinion gears about said convex surface of said cross pins.

14. A differential as set forth in claim 13 wherein the convex surface of said central bore define an arc that forms a part of a theoretical circle.

15. A differential as set forth in claim 13 wherein the convex surface of said central bore define an arc that forms a part of a theoretical ellipse.

16. A differential as set forth in claim 13 wherein the convex surface of said central bore define an arc that forms a part of a theoretical curve.
